(19) United States
(12) Patent Application Publication
(10) Pub. No.: US 2015/0127529 A1
(43) Pub. Date: May 7, 2015

(54) METHODS AND SYSTEMS FOR MOBILE PAYMENT APPLICATION SELECTION AND MANAGEMENT USING AN APPLICATION LINKER

(71) Applicants: Oleg Makhotin, Castro Valley, CA (US); Christian Aabye, Foster City, CA (US); Kiushan Pirzadeh, Foster City, CA (US)

(72) Inventors: Oleg Makhotin, Castro Valley, CA (US); Christian Aabye, Foster City, CA (US); Kiushan Pirzadeh, Foster City, CA (US)

(21) Appl. No.: 14/534,037

(22) Filed: Nov. 5, 2014

Related U.S. Application Data
(60) Provisional application No. 61/900,339, filed on Nov. 5, 2013.

(51) Int. Cl. G06Q 20/08; G06Q 20/32

(52) U.S. Cl. CPC G06Q 20/08; G06Q 20/32
USPC 705/39

(57) ABSTRACT

An application linker system that manages a plurality of application identifiers associated with a plurality of payment applications present on a device is disclosed. The application linker may manage relationships between application identifiers and payment applications that are provisioned for secure storage on a device. For example, a transaction can be conducted between a portable communication device and an access device. The method includes receiving a request for available payment applications located on the portable communication device from the access device, determining application identifiers associated with payment applications on the device, and sending a list of available payment applications including the application identifiers to the access device. The payment applications store payment information associated with one or more consumer accounts. One of the application identifiers is associated with two or more payment applications.

### CROSS-REFERENCES TO RELATED APPLICATIONS

This application is a non-provisional of and claims the benefit of priority to U.S. Provisional Application No. 61/900,339, filed Nov. 5, 2013, which is hereby incorporated by reference in its entirety for all purposes.

### BACKGROUND

In a payment transaction conducted using an electronic device such as a mobile phone, a merchant point-of-sale (POS) system can identify payment routing and processing options associated with a credit card that has been added to a payment application on the mobile phone. Application identifiers can indicate to a POS system payment processors, issuers, product types, and/or other payment capabilities associated with each payment application installed on a device. Each of the payment applications and/or accounts (e.g., credit cards) provisioned to a device include a different application identifier along with the specific account information.

Some payment applications and/or accounts may be associated with multiple application identifiers where each application identifier may have its own application instance including payment information within a secure domain on a secure memory. For example, in order to allow for a debit card issued by one transaction processing network (e.g., VisaNet™) to be used to process transactions over other transaction processing networks (e.g., MasterCard™) which did not issue the debit card, two payment applications may be installed with two different application identifiers. For example, the two payment applications may implement a network-specific application identifier and a network-generic or multiple-network application identifier that may be processed by more than a single payment processing network. As such, multiple payment applications with multiple application identifiers may be associated with the same underlying account information.

As an example, a mobile phone may have 4 different payment applications specifically associated with 4 different payment card accounts. Each could have a different application identifier for each of four existing payment networks. In this case, the mobile phone might then have 64 different application identifiers associated with 64 different payment information entries associated with the different card accounts. It is difficult and resource intensive to provide separate application identifier entries for each payment application and/or payment account installed through a payment application stored on a secure memory. Additionally, determining the available payment applications and conveying the configuration information to a POS is also time and resource intensive.

Further, for each update and/or configuration change to the various payment applications and/or associated payment information stored in the payment applications, a separate update would occur. This leads to extensive use of resources

Embodiments of the invention address these and other problems, individually and collectively.

### BRIEF SUMMARY

Embodiments of the present invention implement an application linker system that manages a plurality of application identifiers associated with a plurality of applications present on a portable communication device. For example, the application linker may manage the relationships between application identifiers and payment applications that are provisioned or otherwise stored on a secure element or other secure storage of a portable communication device.

Embodiments of the present invention allow establishing multiple payment applications with multiple application identifiers (AIDs) pointing to or otherwise associated with these payment applications. The payment applications may be present in different form factors, such as plastic cards or mobile NFC phones. Each instance of the payment application can be dynamically (during personalization or after the application instance has been personalized) assigned with one or more application identifiers (AIDs) pointing to the application linker applet.

As a result, an access device (e.g., POS terminal) can select a particular application identifier and eventually a payment application to which it is linked when a contactless card or mobile NFC device is presented the access device. The application identifier can be linked to one or multiple payment applications, so when it points to multiple payment applications, the payment application that is active or has the highest priority (if none active or all are active) may be selected for a transaction.

Also, when the access device supports multiple application identifiers that are also supported by the portable communication device (e.g., card or mobile device), the payment applications in the portable communication device may have priorities for selection of only one payment application or only one payment application may be active at a time to avoid collision.

One embodiment is directed at a method for initiating a transaction between a portable communication device and an access device, the method comprising a processor receiving a request for available payment applications located on the portable communication device from the access device and determining application identifiers associated with payment applications on the portable communication device. The payment applications store payment information associated with one or more consumer accounts and at least one of the application identifiers is associated with two or more of the payment applications. The method further comprises sending a list of available payment applications to the access device where the list of available payment applications includes the determined application identifiers.

Another embodiment is directed to a portable communication device comprising a processor and a computer-readable medium coupled to the processor, the computer-readable medium comprising code, executable by the processor, to perform a method. The method comprises receiving a request for available payment applications located on the portable communication device from the access device and determining application identifiers associated with payment applications on the portable communication device. The payment applications store payment information associated with one or more consumer accounts and at least one of the application identifiers is associated with two or more of the payment applications. The method further comprises sending a list of available payment applications to the access device where the list of available payment applications includes the determined application identifiers.

Another embodiment is directed at a method for initiating a transaction using a payment application on a portable communication device, the method comprising an access device identifying the presence of a portable communication device, sending a request for available payment applications to the portable communication device. The method further comprises receiving a list of the available payment applications from the portable communication device, where the list includes application identifiers, and where at least one of the application identifiers is associated with two or more payment applications on the portable communication device. The method further comprises determining supported application identifiers from the list of the available payment applications and selecting an application identifier from the supported payment applications. The method further comprises sending a selection message including the selected application identifier to the portable communication device in order to obtain payment information associated with the selected application identifier.

Another embodiment is directed at an access device comprising a processor and a computer-readable medium coupled to the processor, the computer-readable medium comprising code, executable by the processor, to perform a method. The method comprising identifying the presence of a portable communication device and sending a request for available payment applications to the portable communication device. The method further comprising receiving a list of the available payment applications from the portable communication device, where the list includes application identifiers and where at least one of the application identifiers is associated with two or more payment applications on the portable communication device. The method further comprising determining supported application identifiers from the list of the available payment applications, selecting an application identifier from the supported payment applications, and sending a selection message including the selected application identifier to the portable communication device in order to obtain payment information associated with the selected application identifier.

These and other embodiments of the invention are described in further detail below.

### BRIEF DESCRIPTION OF THE DRAWINGS

FIG. 1 is a block diagram illustrating a system for conducting a transaction using a portable communication device with multiple payment applications associated with multiple application identifiers, according to an embodiment of the invention.

FIG. 2 shows a block diagram including an exemplary portable communication device and access device, according to an embodiment of the invention.

FIG. 3 shows a block diagram including relationships between application identifiers and mobile payment applications stored by an application linker module present on a secure element of a portable communication device, according to an embodiment of the invention.

FIG. 4 shows an exemplary flow diagram of a method of initiating a transaction between a portable communication device and an access device, according to an exemplary embodiment of the invention.

FIG. 5 shows a block diagram of an exemplary computer apparatus, according to an embodiment of the invention.

FIG. 6 shows a block diagram of an exemplary portable communication device, according to an embodiment of the invention.

FIG. 7 shows a diagram of a portable consumer device that may be used to initiate a transaction, according to an embodiment of the invention.

### DETAILED DESCRIPTION

Embodiments of the present invention are directed to methods, systems, apparatuses, and computer-readable mediums for managing, configuring, and facilitating communication between an access device and a plurality of payment applications on a portable communication device. For example, embodiments may manage relationships between multiple payment applications and multiple application identifiers on a portable communication device in order to simplify selection and management of multiple payment applications on a secure or trusted memory.

Additionally, embodiments allow a mobile payment application to be associated with multiple applications identifiers and allow for selection of a supported payment application during a transaction according to the preferences and/or configuration details of an access device, merchant system, consumer device, and/or any other interested party. For example, some mobile payment applications may be associated with payment information associated with or configured to be processed by multiple payment networks. Accordingly, merchants may desire to select a payment application that provides the best fraud protection, most rigorous authentication processes for users, most reliable transaction processing, most secure transaction environment, and/or any other configuration details of the payment applications and/or underlying payment information associated with the payment applications (e.g., lowest payment network processing fees, etc.).

Embodiments of the present invention are directed systems and methods implementing an application linker that manages a plurality of application identifiers associated with a plurality of payment applications present on a portable communication device. The application linker may manage the relationships between application identifiers, the payment applications, and the corresponding payment information that is provisioned or otherwise stored on a secure element or other secure storage trusted execution environment of a portable communication device.

In some embodiments, an application linker applet may instruct an access device of the application identifiers associated with payment applications that are available on a portable communication device, according to priorities and/or configuration details of the payment applications. The access device can determine supported application identifiers, select an application identifier and/or payment application using the associated application identifier, and use the selected application identifier to obtain payment information from the highest priority payment application that the access device supports.

For instance, the application linker may inform the access device that there are five available payment applications associated with five different payment accounts and with three different application identifiers. In some embodiments, the access device may provide the list of application identifiers and the access device may select a preferred application identifier according to configuration details or preferences of the access device.

In some embodiments, the application linker may provide priorities or preferences associated with the list of application identifiers as well. For example, application identifier number two is priority number one, application identifier number one is priority number three, etc. The preferences may be based on default settings associated with the payment applications (e.g., consumer default selection), authentication techniques and reliability of particular payment applications (e.g., payment applications ranked by security and/or reliability of user authentication technique employed, and/or consumer preferences (e.g., consumer ranking of payment applications and/or card data provisioned into the payment applications),

The access device may analyze the list of payment application priorities and may determine if the access device supports each application identifier, according to priority. For example, the access device may determine the application identifier with the first priority and determine that the access device does not support that payment application. For example, the payment application may be provisioned with payment information that the access device is not capable of processing, may implement an authentication technique that is not supported by the access device (e.g., signature, online PIN, etc.), or may use any other features that the access device may not be capable of supporting. However, the application identifier with the second priority may be supported. Accordingly, the access device may select the application identifier associated with the second priority.

Accordingly, the access device may send a selection command to the application linker of the portable communication device requesting payment information from the payment application associated the application identifier. However, the application linker may have 2 or more payment applications associated with the selected application identifier. Therefore, the application linker may select the relevant payment application based on preferences and/or priority information stored at the application linker. For example, the preferences may be based on default settings associated with the payment applications (e.g., consumer default selection), authentication techniques and reliability of particular payment applications (e.g., payment applications ranked by security and/or reliability of user authentication technique employed, and/or consumer preferences (e.g., consumer ranking of payment applications and/or card data provisioned into the payment applications). Thus, the access device and/or application linker may select a supported and/or preferred payment application for any transaction and the application linker may provide simplified processing, management, and selection of payment applications that are associated with multiple application identifiers.

For instance, there may be three payment applications provisioned on a mobile phone where each payment application is associated with a different payment card. For example, there may be application “A” associated with payment processing network “A” credit card, application “B” may be associated with a payment processing network “B” credit card, and application “C” may be associated with a payment processing network “C” debit card. Each of the payment applications may be associated with a different application identifier (e.g., A000000031010, A000000049999, and A000000051020). Further, in some embodiments, the payment applications may be associated with more than one application identifier that allows the card information to be used with more than one particular payment processing network. For example, application C may have two different application identifiers associated with the payment application and one underlying debit card (payment processing network “C” debit card). For example, one of the application identifiers may be associated with a network-generic debit account that may be processed by any payment processing network (e.g., VisaNet™, MasterCard™, American Express™, etc.) and the other application identifier may be associated with only payment processing network “C”. However, an access device (e.g., point of sale (POS) terminal) may only support payment applications B and C.

The access device may receive the application identifiers associated with each application and the priorities for each application identifier. For example, the application identifier associated with application A may have a first priority because a consumer selected the payment information associated with payment application A as their default payment application and/or payment card. Next, the application identifier associated with application C (which is associated with a particular payment processing network) may be second because the application provider for application C may provide the most robust consumer authentication during account provisioning and thus the application is more secure than other applications. Further, the application identifier associated with application B may be third because it's authentication processes are less robust than the other payment applications (A and C). Finally, the application identifier associated with application C (which is with a generic payment processing network application identifier) may be fourth because it is associated with a lower transaction amount and/or limit than the other payment applications. These examples are illustrative only and any other suitable reasons for the preferences may be implemented.

Accordingly, some of the application identifiers may be associated with a same payment application as well as the same payment information (e.g., three accounts associated with three different mobile applications but with four different application identifiers). For example, a payment application associated with an account at Bank D may have an application identifier that is associated with one payment processor network (e.g., payment processing network “C”) and a generic processor application identifier (i.e., that may be processed by other payment processors). The payment processing network “C” application identifier may be assigned a higher priority and the generic application identifier may be assigned a lower priority based on the preferences of Bank D. However, if an access device does not support mobile payments associated with payment processing network “C”, but supports the network-generic processing application identifier, the network-generic application identifier may be selected to process a payment. Alternatively or additionally, in some embodiments where the access device is configured to override the application linker preferences, if the access device supports both application identifiers, the access device may select the lower priority application identifier based on overriding preferences of the access device.

Accordingly, when a payment application is presented by a portable device, an application linker may provide a list of available application identifiers provisioned on the portable communication device to an access device so that the access device may select a supported payment application. For example, an access device may have a list of application identifiers it is configured to support and the access device may compare the list of supported application identifiers to those application identifiers provided by the application linker. For instance, if the merchant supports a generic network debit application identifier, the access device may select that application identifier, use the selected application identifier to obtain payment information from a mobile payment application on the portable device, and initiate a transaction using an appropriate debit network for processing transactions associated with the type of payment information received from the portable device.

Thus, when an access device communicates with a portable communication device, the access device may receive the application identifiers stored within a payment application routing table managed by the application linker. The payment application routing table may contain the list of all available application identifiers associated with the payment applications installed on a secure element or other secure memory on the device in order of priorities (or with the priorities indicated). Accordingly, the access device may search through the list and may determine the highest priority application identifier which the access device supports. Accordingly, the access device may then select an application identifier that is supported by the access device while communicating with a single application linking module instead of various independent payment applications.

The access device may then send a communication to the application linker using the selected application identifier which may forward the request to a particular payment application associated with the selected application identifier. The selected application may then be selected for payment (according to priorities or configuration settings for the payment application where a selected application identifier is associated with multiple payment applications) and may provide the appropriate authentication and payment information to the access device for initiation of a transaction.

Accordingly, the application linker provides dynamic connections for many-to-many solutions with multiple application identifiers pointing to multiple payment applications in different combinations and associations between application identifiers and payment applications. Furthermore, the application linker may allow for dynamic storage and update of the relationships between application identifiers and payment applications without requiring updates to each specific payment application and/or the payment information stored within a payment application.

In some embodiments, an application identifier (AID) may be standardized to identify a payment system for a particular payment application associated with a particular payment card or account. For example, a Visa™ system application identifier may include A00000003, and a MasterCard™ application identifier may include A00000004. The application identifier may also include additional data including a product identifier (e.g., Visa™ debit cards use 1010), an issuer identifier (e.g., bank identification number (BIN) or other indicator), and any other relevant information. Further, the issuer identifier may include an extension to identify the specific card associated with the issuer as the issuer may issue more than one card (i.e., product type). Accordingly, the application identifier may be used to determine the payment processing network associated with the payment application. For example, the application identifier may be used to determine the payment processing network configured to process the payment information stored in the payment application. Thus, the application identifier allows the access device to determine if the access device is configured to process the payment information associated with the payment application.

Additionally, in some embodiments, a consumer may set priorities for each individual payment application and/or payment account. For example, a first issuer card may be set as the preferred card (e.g., priority number 1), a second issuer card may be the second priority card (priority number 2), and a third issuer may be the third priority card (priority number 3). Accordingly, the application identifiers associated with the various card may then assigned with those priorities. For example, since the second card has two application identifiers associated with it, the second priority card may have a first application identifier with priority number 2 and a second application identifier with priority number 3. Thus, the third issuer card would have an application identifier priority number of 4.

The multiple application identifiers (AIDs) may be used for at least two different purposes. First, the terminal can see the generic application identifier and the processor specific (e.g., Visa™) application identifier. Accordingly, the terminal (i.e., the merchant operating the terminal) can decide whether the terminal wants to route the transaction into the Visa™ network or an alternate network. Therefore, the merchant has the choice of which network to use. Accordingly, if a first payment processing network is more or less expensive, then the merchant can choose the payment processing network they wish to send the transaction through.

Additionally, if the authentication processing is more rigorous and/or the fraud risk is lower for a particular payment application, the merchant may select the preferred payment application. For example, each application identifier (AID) may have different authentication methods associated with the processor for which it is configured to be used with. For example, some payment processing networks may use signature authentication, but other payment processing networks may capture an online PIN for account holder verification. Accordingly, the portable communication device may prompt the consumer for the particular authentication and/or validation method associated with the application identifier that is selected by the access device, not necessarily the payment application being used. Accordingly, the payment application may validate the consumer differently depending on the application identifier being used for the transaction.

For example, a particular application identifier may indicate that these payment applications require specific authentication methods (e.g., challenge response, password entry, etc.). Depending on what the network associated with the application identifier actually supports, the selected application may request cardholder authentication.

Accordingly, embodiments of the present invention provide an application linker that provides a proxy layer which allows an access device to select an application with a corresponding application identifier that it supports. Therefore, instead of having to communicate with each applet individually and determining which application identifiers the particular application supports, the application linker provides the list of available application identifiers in a single message that allows the access device to determine the best supported option for any and all payment applications installed on the portable device. Accordingly, embodiments provide more efficient, easier to manage, and more flexible system that allows for dynamic linkage changes and management of relationships between payment applications and application identifiers.

Prior to discussing embodiments of the invention, description of some terms may be helpful in understanding embodiments of the invention.

An “application” may include any software module or modules configured to perform a specific function or functions when executed by a processor of a computer. For example, a “payment application” may include any software, code, application, or any other module that is configured to store and provide payment information for a transaction when executed by a processor. For instance, a payment application may store sensitive payment information (e.g., account identifier, expiration date, card verification value (CVV), etc.) on a secure memory or trusted execution environment (e.g., secure element). The sensitive payment information may be accessed by requesting the payment information from the payment application using an application identifier or other address information for accessing the correct payment application. Any number of communication protocols may be used to access the payment information from the payment application and use the received payment information in a payment transaction.

“Payment information” may include any data that may be used to identify an account and use the account for a payment transaction. For example, payment information may include payment credentials (e.g., primary account identifier (PAN), expiration date, card verification value (CVV), etc.), personal information associated with a user or a consumer (e.g., name, billing address, residential address, date of birth, etc.), account information (e.g., issuer identifier (BIN), account issuance date, etc.), cardholder verification information (e.g., passcode, password, personal identification number (PIN), etc.), authentication process for transaction processing (e.g., online PIN, signature, etc.), and/or any other suitable or relevant information for performing a transaction.

An “application identifier” may include any information that may identify an application on a device or provide information about an application on the device. For example, an application identifier may include an identifier that may be used by a device to address a particular secure domain within a trusted execution environment (e.g., a secure element), and may inform a secure element or a payment application stored on a secure element as to the secure application from which to obtain data. Additionally, in some embodiments, an application identifier may indicate information about the application. For instance, an application identifier may indicate a payment network (e.g., VisaNet™), a type of account or product associated with the application (e.g., debit, credit, loyalty, etc.), account-related information (e.g., platinum level account, gold level account, etc.), an account issuer (e.g., Bank A), and/or any other information about an application or underlying data associated with the application. For instance, in some embodiments, the application identifier may be standardized to identify an application provider (e.g., payment network) and an application type (e.g., account or product type, account issuer, etc.) associated with each application. For instance, the application identifier (A000000031010) may identify a payment network (A00000003) associated with card data provisioned on a device and the account type associated with the identified application provider (1010). Accordingly, the application provider may be identified as payment network A and the application associated with 1010 of applications from payment network A includes a debit card type of account. Further, the application identifier 1010 could also identify an issuer associated with the provisioned account and/or payment application.

A “network-generic application identifier” or “multiple-network application identifier” may identify a payment application with payment information that may be routed and/or processed using a variety of different payment networks. For example, in some embodiments, a network-generic application identifier may indicate a payment application that includes payment information that may be used by two or more proprietary networks to process a transaction initiated by a payment application identified by the application identifier.

A “network-specific application identifier” may identify a payment application with payment information that may be routed and/or processed using a specific payment network. For example, a payment application that is configured to process payments through one of, for example, VisaNet™, MasterCard™, or American Express™ payment networks may be identified using a network-specific application identifier.

A “selection message” may include any data, information, or signal that indicates a selection of one or more options provided to a system. For example, a selection message may be sent in response to an access device receiving a list of available payment applications including the application identifiers associated with the payment applications. Accordingly, in response, a selection message may include an application identifier for the payment application that is being selected by the access device. Additionally or alternatively, the selection message may have enough information to further limit the choices available, and the ultimate selection decision may be left to the receiving entity. For example, in some embodiments, an access device may select an application identifier that the access device supports and send a selection message including the application identifier to inform the card or device of the access device's selection. However, in some embodiments, there may be multiple payment applications associated with the application identifier so the payment device may select a payment application associated with the selected application identifier. The payment device may make this selection based on any number of criteria including the priorities of the payment applications, a default or status setting (e.g., active, suspended, etc.) associated each payment application, based on the transaction information, etc.

A “payment application indicator” may include any information that identifies a particular payment application and corresponding payment information on a device. For example, a payment application indicator may include any alphanumeric characters, symbols, graphics, etc., that are associated with a particular payment application. For instance, in some embodiments, the payment application indicator may include a standard or registered identifier for a payment application provider such that an access device may identify the particular payment application. Alternatively or additionally, the payment application indicator may be set or designated by an application linker module provider, a payment application provider, an access device manufacturer, payment processing network, or any other entity within the transaction processing system. For example, a payment application provider may set an exemplary payment application indicator associated with a payment application. The payment application indicator may be used in conjunction with an application identifier to identify a specific payment application installed on a portable device where the application identifier associated with the payment application may identify more than one payment application.

A “relationship” may include any connection or correlation between two pieces of data. For example, a relationship may indicate an association between an application identifier and a payment application, where the payment application may be identified by system or device through an application identifier. Further, relationships are not necessarily exclusive and the pieces of data may have relationships with other data, systems, identifiers, etc. For example, in some embodiments, a payment application may have a relationship with two or more application identifiers and vice versa. For instance, a payment application may have two different payment accounts provisioned or stored in the payment application and the payment application may have two different application identifiers associated with the two different payment accounts. Additionally or alternatively, an application identifier may have a relationship with two or more payment applications. For instance, a network generic application identifier may be used by multiple different payment networks, issuers, etc. to process payments across many different payment networks using a single application identifier, account identifier, and/or payment network identifier. Additionally, a payment application and an application identifier may have a traditional one-to-one relationship as well where an application identifier identifies a payment application, payment network, and/or any other relevant information.

Furthermore, a relationship may be temporary, dynamic, and/or alterable. For instance, in some embodiments, a relationship between an application identifier and a payment application may be dynamically changed or updated to add an association between a new or an existing payment application and a new or existing application identifier. For example, a payment application routing table may be updated to include an association between a payment application and an application identifier. Further, the relationships stored in the payment application routing table may be updated at any time because the underlying payment information associated with the payment application may not be altered by the routing table update. Accordingly, relationships may be altered at any time before, during, or after a payment application provisioning and/or personalization process. Additionally, relationships may be stopped or ended. For instance, an association between an application identifier and a payment application in a payment application routing table may be removed before, during, or after a provisioning and/or personalization process of a payment application is completed.

A “routing table” may include any data that allows for contact or communication with a system, module, component, or entity. For example, a routing table may include relationship information for indicating an association between two systems, identifiers, or any other data. Additionally or alternatively, the routing table may include address information for the entities associated with a request such that the routing table may forward information, requests, updates, etc., on behalf of a requestor to a destination system, module, component, or entity. Additionally or alternatively, the routing table may provide an address to a requestor to allow the requestor to directly send information, a request, a response, etc., to an associated system, module, component, or entity identified by the routing table address information. The address information may include any address in a memory, kernel address, computer component address, network address, or any other information configured to allow a computer module and/or component to access data and/or forward information to a module, application, component, and/or system. A routing table may be stored in any suitable memory, database, secure area, etc., that is accessible by an entity configured to access and use the routing table.

“Application provisioning” may include any process where an application or application information is installed, delivered, uploaded, or otherwise transferred to a device. For example, payment application provisioning includes a process of preparing a secure element (or other trusted execution environment) to receive a payment application configured to securely hold sensitive account information and use the sensitive account information to initiate payment transactions.

“Application personalization” may include any process where a payment application is installed with account or other personal information associated with a consumer. For example, a payment application personalization process includes the delivery, installation, and secure storage of a consumer's payment credentials (e.g., account identifier, expiration date, card verification value (CVV), etc.) and other payment information that may then be used by a payment application to initiate a transaction.

A “module” may include any component or sub-component of a system. For example, a module may include a software program configured to perform a particular function when executed by a processor.

### I. Exemplary System for Mobile Payment Application Selection and Management Using an Application Linker

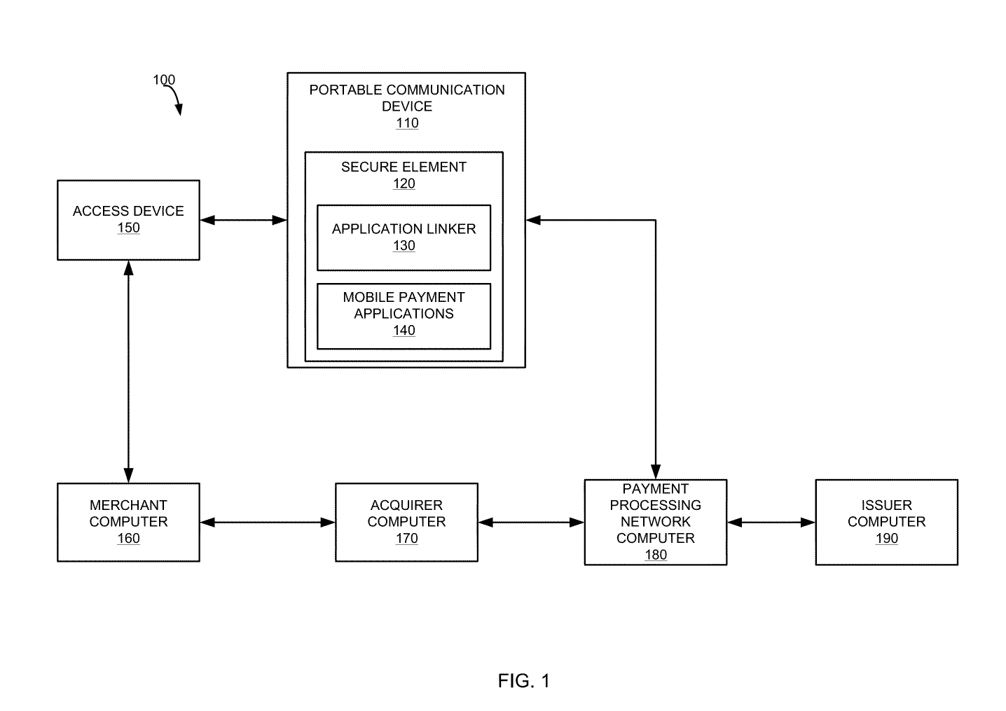

Referring now to FIG. 1, a functional block diagram illustrating the primary functional elements of an exemplary transaction processing system incorporating a portable communication device 110 with an application linker 130 is shown. It is to be understood that embodiments of the invention may include more than one of the components shown individually in FIG. 1. Additionally, some embodiments of the invention may include fewer than all of the components shown in FIG. 1.

The exemplary transaction processing system may include a consumer (not shown), a portable communication device 110 associated with the consumer (or other account holder), an access device 150, a merchant computer 160, an acquirer computer 170, a payment processing network computer 180, and an issuer computer 190. The portable communication device 110 may include a secure element 120 or other secure and trusted execution environment. The secure element 120 may include an application linker module 130 and mobile payment applications 140 that may be configured to provide payment information to an access device 150 during a transaction. The various computers may be configured to communicate in any suitable manner using any suitable communication network. Although the entities are shown as coupled to particular entities, the entities may be configured to communicate through any other suitable interfaces and some entities may be removed and/or added to the system depending on the configuration of the system.

In the following description, an “acquirer” is typically a business entity (e.g., a commercial bank) that has a business relationship with a particular merchant. An “issuer” is typically a business entity (e.g., a bank or credit union) which issues a payment device (such as a credit card, debit card, smart card, prepaid device or contactless device) to an account owner and which provides administrative and management functions for the payment account. Some entities may perform both issuer and acquirer functions. A payment account may be any account usable in a transaction, such as a credit, debit or prepaid account.

The term “computer” can include a system comprising a processor and a computer readable medium, such as computer memory or other data storage device, coupled to the processor. The computer readable medium stores code executable by the processor. The term “server computer” can include a computer or cluster of computers. For example, the server computer can be a mainframe, a minicomputer cluster, or a group of servers functioning as a unit. In one example, a server computer may be a database server coupled to a Web server. Data transfer and other communications between components such as computers may occur via any suitable wired or wireless network, such as the Internet or private networks.

In a typical transaction, a payment device such as a portable communication device 110 (also referred to as a mobile device) or portable consumer device, interfaces with an access device 150 (or, in some embodiments, with merchant computer 160) to initiate a transaction. Typically, the portable consumer device 110 is hand-held and compact so that it can fit into a consumer's wallet or pocket (e.g., pocket sized). Specific examples of portable consumer devices include payment cards such as smartcards with chips, debit devices (e.g., a debit card), credit devices (e.g., a credit card), or stored value devices (e.g., a stored value card or “prepaid” card).

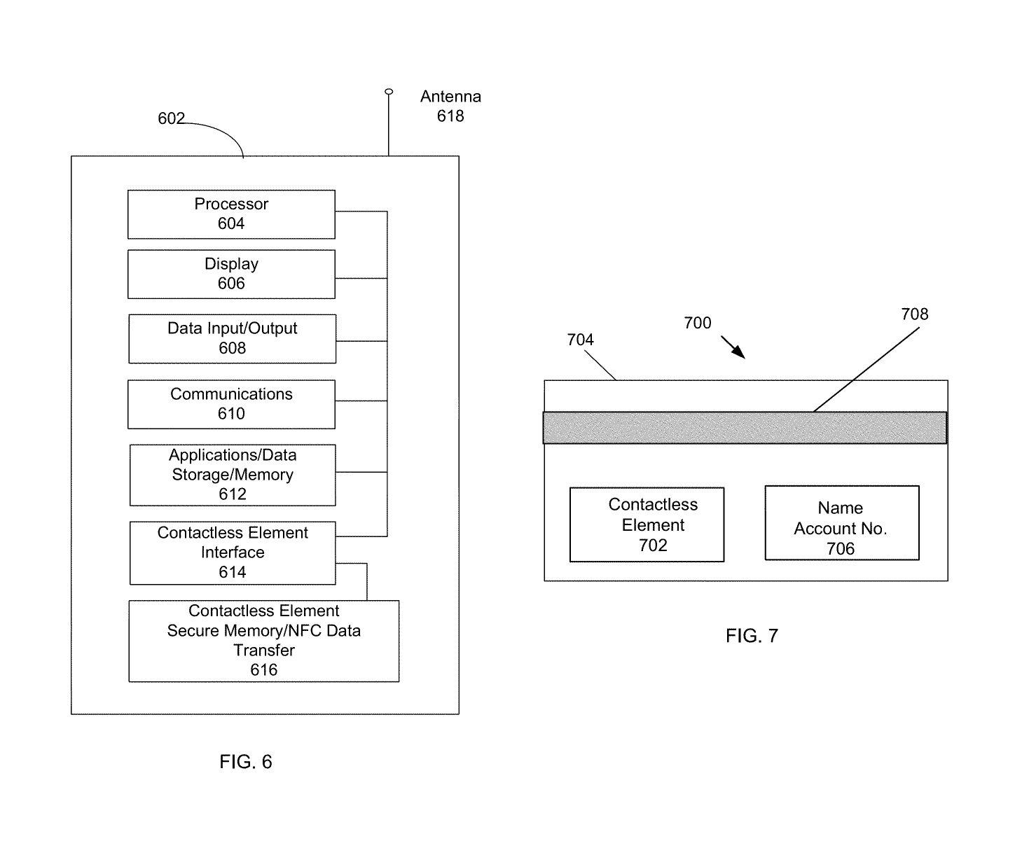

A portable communication device 110, may be, for example, a mobile device including a cellular or wireless telephone (e.g., a smartphone), personal digital assistant (PDA), portable computer (e.g., tablet or laptop computer), pager, or other portable device carried by the payment account holder. A portable communication device 110 and a portable consumer device (not shown) are described further below with reference to FIGS. 6 and 7, respectively. Examples of access devices 150 include point of sale (POS) devices, cellular phones, PDAs, personal computers, tablets, handheld specialized readers, set-top boxes, electronic cash registers, automated teller machines (ATMs), virtual cash registers, kiosks, security systems, access systems, and the like. Access devices may use means such as radio frequency (RF) readers to interact with the portable communication device 110 through contactless communication.

For example, communication may occur between a contactless element of portable communication device 110 and an access device 150, such as a merchant device reader or point of sale terminal, by using a wireless communications mechanism, such as near field communications (NFC), radio frequency (RF), infra-red (IR), optical communications, etc. The account identifier or other payment account information may be stored on a secure element 120 or other secure memory of the mobile device 110.

The secure element 120 may include a secure memory or other trusted execution environment that provides a higher level of security than general memory. For example, the secure element may only be accessed by authorized parties with credentials, keys, or other cryptographic information that indicates the entity or client is authorized to access the secure element. The secure element may include hardware, software, or a combination of hardware and software and the secure element may comprise a separate processor and/or system to provide a heightened level of security for data stored therein. Further, the secure element may be implemented by a remote server computer (i.e., in the “cloud”) and data may be securely stored in the remote server computer and delivered to the portable communication device before, during, and/or after a transaction (or other service request).

The secure element 120 may include an application linker module 130 and a plurality of mobile payment applications 140 that are capable of accessing payment information (e.g., an account identifier) securely stored on the secure element 120. The application linker module 130 may generate a list of application identifiers associated with the available payment applications on the secure element 120 of the portable communication device 110. Accordingly, the application linker module 130 may send the list of available payment applications to the access device 150 for selection of one of the available payment applications. However, certain access devices may only be configured to receive and process particular types of information associated with particular payment applications. For example, if the access device 150 is only configured to process transactions using a certain payment processing network (e.g., VisaNet™), the access device 150 may not process transaction information originating from payment applications that are only configured to provide information in the format for processing with a different payment processing network (e.g., MasterCard™) Accordingly, access devices and portable communication devices may perform a payment application identification and selection process before a transaction may be initiated.

The application linker module 130 may manage, facilitate, and route the appropriate commands, application identifiers, priorities associated with the application identifiers, and any other information necessary to complete a transaction using the payment applications on the mobile communication device 110. Accordingly, the application linker 130 may provide a list of available application identifiers along with priority information to an access device 150 during transaction processing. The access device 150 may select the highest priority supported application identifier and may request payment information and/or account information from a payment application associated with the supported application identifier. Accordingly, the application linker 130 may determine one or more payment applications associated with the application identifier, may select a preferred payment application, and may route the request for the payment information to the appropriate payment application.

The mobile payment applications 140 may include two or more software modules installed or provisioned on the secure element 120 that are capable of providing payment information stored on the secure element 120 during a transaction. The mobile payment applications 140 may be provisioned on the secure element 120 by any entities within a mobile communication ecosystem (e.g., mobile network operator, device manufacturer, payment processing network, etc.). Further, issuer updates and other maintenance information may be sent to the mobile communication device from the payment processing network (as shown in FIG. 1) or through any other suitable entity to update the payment account information, issuer information, application lifecycle information, or any other suitable information that allows the one or more mobile payment applications 140 to initiate transactions through the transaction processing system.

The mobile payment applications 140 may be associated with one or more application identifiers (AIDs) that identify payment information associated with one or more accounts provisioned on the mobile payment application 140. The application identifiers associated with the provisioned payment information on the secure element 120 may be reported to the application linker module 130 which may manage relationships between application identifiers and mobile payment applications 140 on the portable communication device 110.

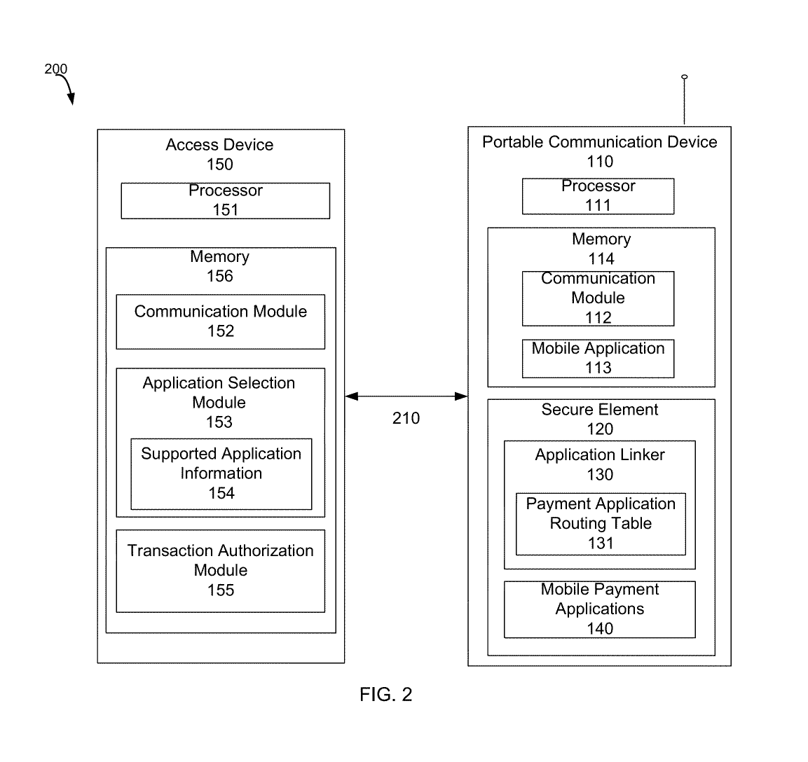

The access device 150 may communicate with the portable communication device 110 to obtain application information (e.g., application identifier, consumer account information, payment credentials, cardholder verification results, etc.) from the one or more payment applications. FIG. 2 shows a more detailed view of the access device 150 and portable communication device 110 according to an exemplary embodiment of the present invention.

The access device 150 may include a processor and a memory 156 including a communication module, an application selection module 153, and a transaction authorization module 154. Although not shown in FIG. 2, the modules may be contained on a computer-readable medium coupled to the processor, the computer-readable medium comprising code, executable by the processor, for performing the functionality described herein.

The communication module 152 of the access device 150 may include any code, application, or any other software module configured to interface with an antenna or other communications hardware of the access device 150 to communicate with a portable communication device 110. In some embodiments, the antenna may be configured for proximity, contactless, or other short-range or long-rang communication protocols.

The communication module 152 and an associated data processor may be configured to identify the presence of a portable communication device 110 when within communication range. For example, the communication module may ping (i.e., send a periodic message in an attempt to identify a device within communication range) or otherwise attempt to find suitable devices to communicate with periodically. Alternatively or additionally, the access device 150 may wait to receive communications from a device within communication range. Any suitable communication techniques and methods may also be used to identify and initiate communication with a device within communication range.

The communication module 152 and an associated data processor may be configured to send and receive a number of different communications and messages with a portable communication device 110. For example, the communication module and an associated data processor may be configured to send a request for available payment applications to the portable communication device 110 which may be processed by an application linker module 130, mobile application 113, a secure element 120, or any module of the portable communication device 110 configured to communicate with the access device 150. Accordingly, the access device 150 may use any suitable communication protocol that is configured to be processed by a mobile application, secure element 120, application linker module 130, mobile payment application 140, and/or any other relevant application of the portable communication device 110.

Further, the communication module 152 and an associated data processor may be configured to receive communications from the portable communication device 110. For example, the communication module may receive a list of the available payment applications from the portable communication device 110 in response to the request for available payment applications. The list of available payment applications may include application identifiers which identify a type of payment application, a payment network associated with a payment application, a type of payment information stored within a payment application, account features (e.g., type of account, account features, etc.), and any other relevant information associated with a payment application and/or account information provisioned or otherwise associated with the payment application.

The application selection module 153 may include any application, code, and/or any other software configured to select a supported application on a portable communication device 110 in which to initiate a transaction. For example, the application selection module 153 and an associated data processor may be configured to obtain the list of available payment applications from the communication module and may determine supported applications from the list of available payment applications.

The application selection module 153 may determine supported applications from the list of available payment applications through any suitable manner. For example, the application selection module 153 may compare application identifiers from the list of available payment applications to supported application information 153A present on the access device 150. For instance, in one embodiment, the application selection module 153 may use supported application information 153A stored in the access device 150. The supported application information 153A may include application identifiers associated with those payment applications, payment information, and/or account information which the access device 150 is configured to process. For instance, the access device 150 may compare the application identifiers received in the list of available payment applications to application identifiers in the supported application information 153A to determine those application identifiers that are supported and/or configured to be processed by the access device 150.

Additionally and/or alternatively, where the access device 150 supports or matches multiple application identifiers from the list of available payment applications, the access device 150 may use priority information and/or preferences stored in the supported application information 153A to determine a preferred application for use in the transaction. Accordingly, the access device 150 may determine a preferred payment application from at least two payment applications included in the list of available payment applications according to preferences stored by the access device 150. The preferences may include any suitable information including authentication and configuration options of the payment applications (type of authentication and/or level of authentication performed), geographical restrictions associated with the access device 150 (e.g., international vs. domestic transaction for the payment application), based on transaction specific information (e.g., a transaction amount threshold or limit, time limit, etc.), or based on any other suitable information.

Once the best match of the payment applications is determined, the application selection module 153 may select an application identifier from the supported payment applications by generating and sending a selection message including the selected application identifier to the portable communication device 110 in order to obtain payment information associated with the selected application identifier. The application selection module 153 may interface with the communication module in order to communicate the selection message including the identified application identifier to the portable communication device 110.

The transaction authorization module 154 may include any application, code, and/or any other software configured to initiate payment transaction processing. For example, the transaction authorization module 154 may receive payment information from a portable communication device 110 and may initiate transaction using payment information obtained from the selected payment application. The transaction authorization module 154 may generate an authorization request message for the transaction or may pass the payment information to a merchant computer 160 for generation of an authorization request message for payment network processing.

The portable communication device 110 may include a processor 111, a memory 114 including a communication module 112 and a mobile application 113, and a secure element 120. The secure element 120 may include an application linker module 130 and mobile payment applications 140 including provisioned payment information associated with consumer account information and/or payment credentials. The application linker module 130 may include a payment application routing table 131 that stores relationships between application identifiers and the mobile payment applications 140 stored in the secure element 120.

The communication module 112 of the portable communication device 110 may include any code, application, or any other software module configured to interface with an antenna or other communications hardware of the portable communication device 110 to communicate with an access device 150. In some embodiments, the antenna may be configured for proximity, contactless, or other short distance or proximity communication protocols. Any other suitable communication networks, protocols, and hardware may be used as well.

The communication module 112 and an associated data processor of the portable communication device 110 may be configured to identify the presence of an access device 150 within communication range. For example, the communication module 112 may ping or otherwise attempt to find suitable devices to communicate with periodically. Alternatively or additionally, the portable communication device 110 may wait to receive communications from a device within communication range. Any suitable communication techniques and methods may also be used to identify and initiate communication with a device within communication range.

The communication module 112 and an associated data processor may be configured to send and receive a number of different communications and messages with an access device 150. For example, the communication module 112 and an associated data processor may be configured to receive a request for available payment applications from the access device 150. The request for the available payment applications may be processed by an application linker module 130, mobile application 113, a secure element 120, or any module of the portable communication device 110. Further, the communication module 112 and an associated data processor may be configured to send communications to an access device 150. For example, the communication module 112 may send a list of the available payment applications as well as payment information associated with a selected payment application to the access device 150 during a transaction.

The mobile application 113 may include any application, code, or other software module configured to interface with one or more of the mobile payment applications 140 and/or the application linker module 130. The mobile application may allow a consumer to interface with the mobile payment applications 140, add account information to one or more mobile payment applications 140, set priorities for the various payment information and/or payment applications on the device, determine a default payment application, and/or provide any other functionality for managing and/or configuring the application linker module 130 and/or a mobile payment application. Further, there may be more than one mobile application where each mobile application may be configured to interface with a particular payment application as well as the application linker module 130.

The application linker module 130 may include any application, code, or software module installed on the secure element 120 that is capable of performing the methods and functionality described herein. The application linker 130 and an associated data processor may be configured to manage, determine, and communicate a list of application identifiers associated with provisioned or installed payment applications on a secure element 120 (or other secure memory of the mobile communication device 110) as well as the corresponding priorities for the application identifiers. In response to a request for available payment applications on the portable communication device 110, the application linker module 130 and an associated data processor may be configured to determine application identifiers associated with mobile payment applications 140 provisioned on the portable communication device 110 and provide a list of available payment applications to an access device 150.

The application linker module 130 and an associated data processor may be configured to determine the available payment applications through any suitable manner. For example, the application linker module 130 may determine application identifiers associated with payment applications on the portable communication device 110 by searching a payment application routing table 131 for application identifiers associated with mobile payment applications 140 and/or account information that has been provisioned on the secure element 120.

In some embodiments, the application linker module 130 may include all of the application identifiers stored in the payment application routing table 131 in a list of available payment applications. However, in other embodiments, the application linker module 130 may filter and/or qualify those application identifiers provided to in the list of available payment applications to only include application identifiers associated with those payment applications that may be used in a transaction. For example, the application linker module 130 may determine a status of the mobile payment application 140 or associated account information before including an associated application identifier.

In some embodiments, payment applications may be in an active or inactive state and may be ready for use in a transaction or may be disabled from use, respectively. The payment application may be activated or deactivated by any entity within the transaction processing system. For example, a consumer may be capable of setting a mobile payment application status through the mobile application or an issuer, merchant, payment processor, payment application provider, or other entity may activate or deactivate a payment application on a device. Further, in some embodiments, a single payment application may be active at any time and a consumer may select the default or active mobile payment application for use in transactions.

For example, a consumer may activate a single payment application before approaching an access device 150 and the available application identifiers may be those application identifiers associated with the active payment application. In some embodiments, when one payment application is activated, the other payment applications may be deactivated to ensure no collision between communications with the payment application, application linker module 130, or any other components in the system. Accordingly, in such embodiments, the application linker module 130 may determine application identifiers associated with an active payment application on the portable communication device 110 and may not report unavailable payment applications to the access device 150.

Accordingly, the access device 150 can only select the active payment application if there is the mutually supported list of application identifiers associated with the active payment application. If the supported list of application identifiers does not match the application identifiers on the portable communication device 110, an error may be returned to the reader and the reader may display, for example, “Sorry, no application has been selected,” to inform the user that no active payment application is supported.

Accordingly, the application linker module 130 may determine whether the corresponding mobile payment application 140 is currently active and/or determine the preferences associated with the mobile payment application 140 before including the application identifier in a list of available payment applications. For example, if a payment application is not in good standing with an issuer, may not qualify as a top payment application to use (e.g., a consumer sets a limit of the top 3 payment applications be presented to the access device 150), transaction information may not qualify for a mobile payment application 140 (e.g., geographic location indicates that a domestic payment account should be used as opposed to an international payment account), or for any other suitable reason a payment application may not be active and ready for use in a transaction. Accordingly, the payment application routing table 131 may include a current status (e.g., active vs. inactive), transaction restrictions (maximum transaction count, transaction value, etc.), account restrictions or rules (e.g., geographic restrictions, etc.), or any other suitable information for determining available mobile payment applications 140 for a transaction along with the application identifier and associated mobile payment application identifier and/or mobile payment application information.

Additionally, the application linker module 130 may be capable of maintaining, monitoring, updating, and changing the relationships between the mobile payment applications 140 installed on the mobile communication device and the application identifiers (AIDs) associated with the mobile payment applications 140. Accordingly, the application linker module 130 may receive issuer updates, configuration parameters, and any other information from the payment processing network, trusted service managers of issuers, or any other entities within the transaction processing environment to update such relationships at any time during the lifecycle of the payment applications 140.

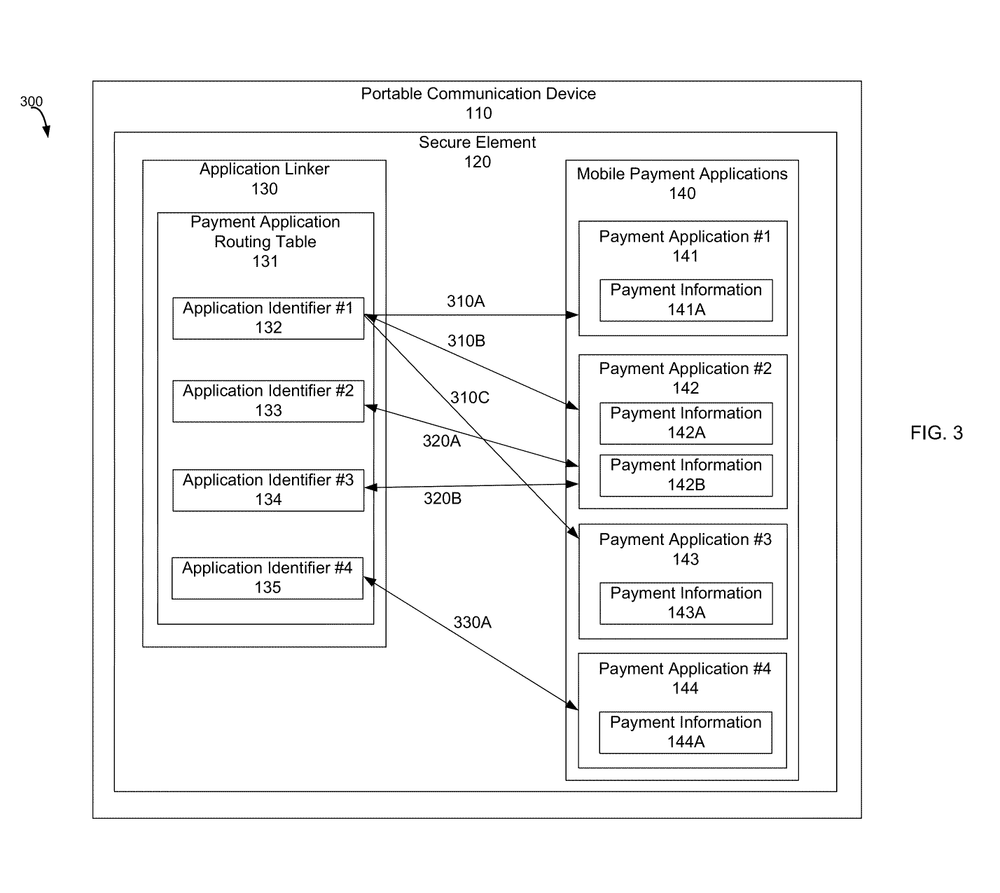

FIG. 3 shows an exemplary diagram of the relationships stored by the application linker module 130 using the payment application routing table 131. For example, FIG. 3 shows the relationships between application identifiers 132-135 of mobile payment applications 141-144 and the multiple payment applications 141-144 on a secure element 120 of a portable communication device 110.

As shown in FIG. 3, the payment application routing table 131 associated with the application linker module 130 may include relationships between application identifiers 132-135 and mobile payment applications 141-144 stored on the secure element 120. The relationships between the application identifiers 132-135 and mobile payment applications 141-144 may include one-to-many, many-to-one, and one-to-one relationships depending on the configuration details associated with the payment application 141-144 and the payment information 141A-144A stored on each mobile payment application 141-144.

For example, in some embodiments, a single application identifier (e.g., application identifier #1 131) may be linked or associated with 310A-C multiple payment applications (e.g., payment application #1 141, payment application #2 142, and payment application #3 143). This relationship may arise in a variety of circumstances including, for example, network-generic or multiple-network debit transaction processing implementations where a generic debit application identifier (e.g., application identifier #1 132) may be linked to multiple mobile payment applications 141-143 (e.g., payment application #1, #2, and #3). Each of the mobile payment applications 141-143 may include payment information 141A-143A associated with a variety of debit accounts (e.g., each of the payment information may identify a different debit account) which may be linked to the network-generic application identifier (e.g., application identifier #1 132) in order to be able to route debit transactions associated with any of the mobile payment applications 141-143 configured with debit payment information 141A-143A to alternate networks at the merchant's or consumer's choice. Further, similar implementations may be used where one application identifier can be shared between payment processing systems (e.g., VisaNet™ and MasterCard™) for country-specific networks like ATM networks. Accordingly, any payment application including payment information associated with either of the payment processing systems country-specific ATM networks would be associated in the payment application routing table to a single application identifier that associates both payment applications with the application identifier that may be shared between the payment processing systems.

For instance, the network-generic application identifier 132 (e.g., application identifier #1 132) may identify a network-generic debit implementation of the various mobile payment applications 141-143 (e.g., payment applications including payment information 141A-143A associated with network-specific debit accounts and network-generic debit accounts). In such circumstances, a payment application (e.g., payment application #2 142) may have one network-specific application identifier (e.g., payment processing network “A” application identifier #2 133) and one generic or multiple network debit application identifier 132 (e.g., an application identifier that may be processed by any of payment processing network “A,” “B,” and “C”) to allow merchants and/or any other entity the ability to decide which network to route transactions over which are initiated using any of the associated payment applications.

The application linker module 130 may manage and facilitate the relationships 310A-C between the application identifier (e.g., application identifier #1 132) and the multiple payment applications (e.g., payment applications #1-#3 141-143) and may configure a list of priorities of the payment applications 141-143 associated with the single application identifier 132. For example, the payment application routing table 131 may include a number of entries associated with the shared application identifier (e.g., application identifier #1 132) with each entry having a different payment application 141-144 and priority number (e.g., 1-3) associated with it. For instance, the application linker module 130 may include a priority number of 1 for the entry associated with the relationship 310A between the application identifier (e.g., application identifier #1 132) and a first payment application (e.g., payment application #1 141) because the user or an issuer associated with the payment information of payment application #1 141 may have configured the payment application 141 to be the default or highest priority payment application associated with the application identifier 132 (e.g., application identifier #1 132). Similarly, the payment application routing table 131 may have priority information associated with the relationships between the application identifier (e.g., application identifier #1 132) and the other mobile payment applications 141-143 (e.g., payment application #2 142 and payment application #3 143). Accordingly, the priority information may be used to select a preferred payment application 141-143 associated with the application identifier 132 when the application identifier 132 is selected by an access device 150.

In some embodiments, the application linker module 130 may select a preferred mobile payment application from the mobile payment applications 141-143 associated with the received application identifier 132 from an access device 150 using stored preferences associated with the various mobile payment applications 141-143. For example, the application linker module 130 may receive a selection message including an application identifier (e.g., application identifier #1 132) from the access device, may determine the payment applications (e.g., payment applications #1-#3 141-143) associated with the identified application identifier (e.g., application identifier #1 132), may determine an active or preferred (or otherwise having the highest priority) mobile payment application (e.g., payment application #1 141) associated with the application identifier (e.g., application identifier #1 132), and may route the selection message to the selected payment application (e.g., payment application #1 141) of the mobile payment applications 140.

Alternatively or additionally, in some embodiments, the application linker module 130 may provide an access device 150 with two different entries of the application identifier (e.g., AID #1 132) on the list of available payment applications where each application identifier entry may include a different priority number associated with the different payment applications (e.g., payment applications #1-#3 141-143). Accordingly, the access device 150 may determine which payment applications the access device 150 supports and select a preferred payment application from the list of available payment applications (e.g., application 141-143) associated with the selected application identifier (e.g., application identifier #1 132).

Accordingly, in some embodiments, the application linker module 130 may keep priorities of the multiple application identifiers in relation to the payment application such that if the payment application is supported by the access device 150, the application identifiers may be selected by the access device 150 according to the priority of application identifiers associated with the payment application. Typically, in such embodiments, a payment application indicator or other identifier of a specific payment application associated with the shared application identifiers may be passed to the application linker and used to identify the specific payment application being selected by the access device. For example, the access device may pass an application identifier associated with multiple payment applications and a payment application indicator in the selection message to inform the application linker as to the selected payment application preferred by the access device 150.

Additionally, as shown by payment application #2 142, in some embodiments, multiple application identifiers (e.g., application identifier #1 132, application identifier #2 133, and application identifier #3 134) can be linked 310B, 320A, and 320B to a single mobile payment application 142 (payment application #2 142).

For example, multiple application identifiers (e.g., application identifiers 132-134) to single payment application (e.g., payment application 142) relationships may be found for mobile payment applications 142 which include both a domestic application identifier (for transactions initiated within the geographic region of the accountholder and/or account issuer) and international application identifier (for transactions initiated outside the geographic region of the accountholder and/or account issuer). For instance, issuers and/or payment processors may use a domestic transaction network for processing domestic ATM transactions but use a world-wide payment processor for international ATM transactions. Accordingly, mobile payment applications 140 provided by the issuer and/or payment processor may include both domestic ATM application identifiers (e.g., ATM country A network identified by application identifier #2 133) and international ATM application identifiers (e.g., payment processor “A” network identified by application identifier #3) associated with a single mobile payment application (e.g., payment application #2 142) and corresponding payment information (e.g., payment information 142A). Any other suitable situations or configurations where one mobile payment application may be associated with multiple application identifiers may be considered as having a many-to-one (application identifier to mobile payment application) relationship. For example, most payment applications implementing the network-generic application identifier example provided above in reference to the one-to-many relationship may also have a payment application with a one-to-many relationship because the network-generic and network-specific application identifiers may point to the same payment application.

Further, note that payment information 142B shows an embodiment where multiple cards with corresponding payment information 142A, 142B may be provisioned onto a single payment application #2 142. For example, if two credit cards are processed by the same payment processor, issued by the same entity, and directed to the same product type, the same payment application may provision both payment information 142A, 142B into the same payment application 142 and in some embodiments, the payment application routing table may include the payment information as an additional variable in the routing table. Additionally, wallets and/or other payment applications which are configured to collate and/or combine payment information may store multiple payment information within a payment application and link the payment information 142A-B through the payment application.

Finally, in some embodiments, a single application identifier can be linked 330A to and/or associated with a single payment application (e.g., application identifier #4 135 and payment application #4 144). This embodiment may capture configurations where, for example, a mobile payment application (e.g., payment application #4 144) includes payment information 144A associated with a credit account which has only one application identifier (e.g., application identifier #4 135) assigned to the credit account.

Additionally, any possible means for linking the application identifiers and the mobile payment applications 140 may be used. For example, the linkage could be established through the internal logic of the application linker module 130 and/or through a communication protocol associated with communicating between secure applications a mobile device or provisioning scripts (e.g., GlobalPlatform™ defined Amendment C). Furthermore, the linkage can be established without the need to personalize the application linker module 130. Accordingly, the payment application may store all the relationship and address information to be used by the application linker 130 and the application linker module 130 may store the relationship between the application identifier and payment information associated with the mobile payment application.

Additionally, the application linker module 130 and an associated data processor may be configured to route communications between an access device 150 and a selected mobile payment application of the mobile payment applications 140. Accordingly, in some embodiments, the application linker module 130 may receive a selection message and provide the selection message to the selected mobile payment application and vice versa. However, in other embodiments, the application linker module 130 may provide a payment application identifier to an access device 150 or other application on the portable communication device 110 and then the access device 150 may select the appropriate mobile payment application using an application identifier supplied by the application linker 130, without passing a selection message or get data request to the application linker module 130 for delivery to the selected mobile payment application.

Furthermore, the application linker 130 allows dynamic updating of the relationships between application identifiers and mobile payment applications 140. For example, an application identifier and a mobile payment application may dynamically be linked and/or unlinked at any time by updating the payment application routing table 131. Accordingly, the application linker module 130 may remove an association between an application identifier and a mobile payment application and/or may add an association between the application identifier and a mobile payment application in the payment application routing table at any time in response to a request from an authorized entity (e.g., application provider, payment network, application linker provider, account issuer, etc.). Furthermore, in some embodiments, an application identifier can be assigned to a mobile payment application after the provisioning process and/or personalization process associated with a payment application is complete and can be updated or removed at any time thereafter.

For example, the application linker module 130 may update the relationship in the payment application routing table 131 to include the updated relationship information in response to a request from an authorized entity. The application linker may then show the application identifier and the payment application as having a relationship during future transactions and may allow an access device 150 to select the application identifier and/or payment application during a transaction in the future. The application linker may update the payment application routing table by determining the address of the identified payment application to be updated and including the address information as well as any other relevant information in the payment application routing table as being associated with the application identifier. Accordingly, the application linker provides a proxy layer which allows application identifiers and/or payment applications to be dynamically linked and updatable at any time.

Thus, because the application linker module 130 provides a proxy layer to contact mobile payment applications 140, the updates to the relationships between the application identifiers and mobile payment applications 140 may be completed during payment application provisioning and/or payment application personalization as well as after payment application provisioning and payment application personalization. Additionally, the list of application identifiers (application identifiers) in the payment application routing table 131 can be pre-provisioned during secure element manufacturing and also can be updated during the life of the secure element 120 by means of secure script updates. Accordingly, the application linker module 130 provides a flexible and dynamic management structure for associating application identifiers and mobile payment applications 140 on a portable communication device 110.

Returning to FIG. 1, after the access device 150 receives the payment account identifier or the payment device identifier, the access device 150 or the merchant computer 160 in communication with the access device 150 generates an authorization request message for the transaction. The data included in the authorization request message (also referred to as an “authorization request”) may include data obtained from a portable communication device 110 as well as other data related to the transaction, the payment account holder, or the merchant, such as one or more of a payment account number, the payment device expiration date, a currency code, the sale amount, a merchant transaction stamp, the acceptor city, the acceptor state/country, etc.

An authorization request message may be protected using a secure encryption method (e.g., 128-bit SSL or equivalent) in order to prevent data from being compromised. In one embodiment, the authorization request message is a standardized interchange message such as an International Organization for Standardization (ISO) 8583 message. An ISO 8583 message includes a message type indicator; one or more bitmaps indicating which data elements are present in the message, and data elements of the message. The authorization request message may comprise routing information as part of or in addition to the interchange message. As part of generating the authorization request message, merchant computer 160 may communicate with a database which stores data such as data regarding the account owner, the payment device, or the account owner's transaction history with the merchant. The merchant computer 160 (or access device 150) transmits the authorization request message to the acquirer computer 170. Acquirer computer 170 then transmits the authorization request to a payment processing network 180.

A payment processing network 180, also referred to as a “payment network,” is a system that may comprise one or more servers, data processing subsystems, networks, and operations used to support and deliver authorization services, exception file services, and clearing and settlement services. A payment processing network may be able to process one or more of credit card transactions, debit card transactions or any other type of commercial transaction. An exemplary payment processing network may include, for example, VisaNet™. Although the system of FIG. 1 only shows one payment processing network, any number of payment processing networks may be implemented in the transaction eco-system to allow the merchant computer 160 to determine the payment processing network 180 that they support and select the appropriate payment application associated with the one or more payment processing networks.

The payment processing network 180 transmits the authorization request message to an issuer computer 190. The issuer computer 190 generates an authorization response message indicating whether the transaction was authorized. The authorization response message is routed back to the merchant computer 160. The authorization response may be displayed by the access device 150 (e.g., a POS terminal), transferred to the portable communication device 110, printed on a receipt, or otherwise conveyed to the payment account holder.

At the end of the day, a normal clearing and settlement process can be conducted by each of the payment processing network. A clearing process is a process of exchanging financial details between an acquirer and an issuer to facilitate posting to the payment account holder's account and reconciliation of the consumer's settlement position. Clearing and settlement can occur simultaneously.

### III. Exemplary Methods

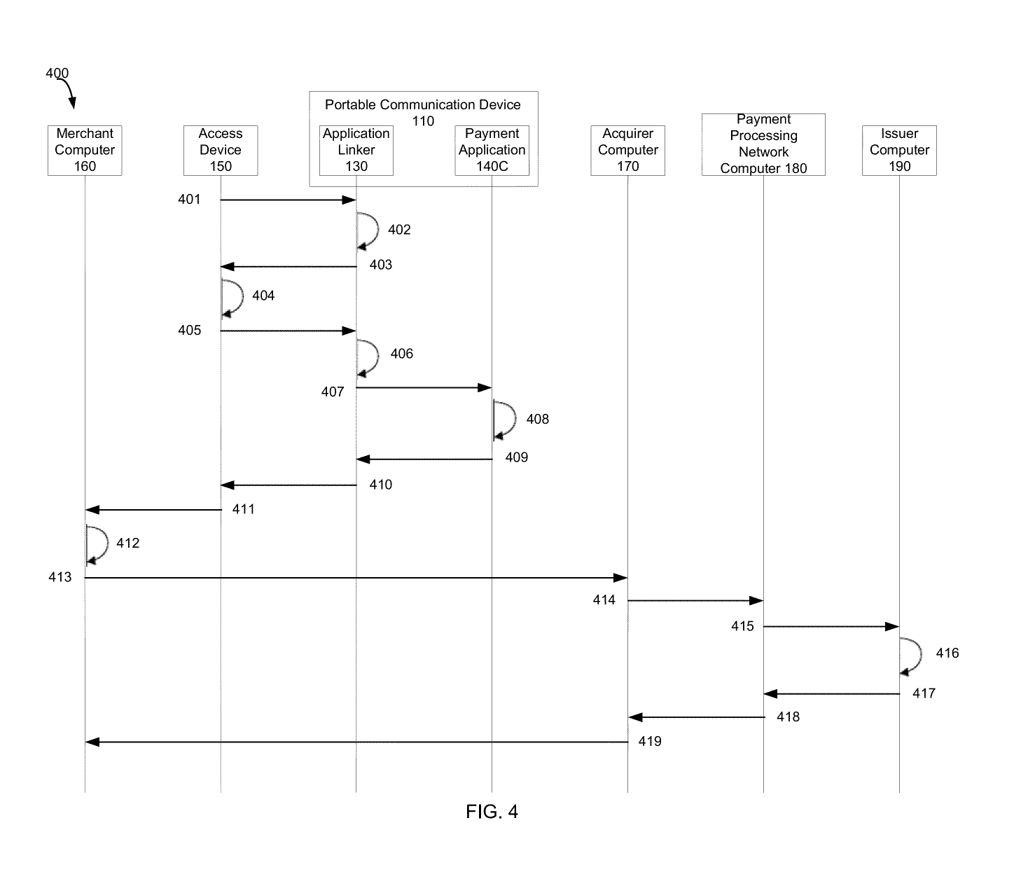

FIG. 4 shows an exemplary flow diagram of a method of initiating a transaction between a portable communication device 110 and an access device 150, according to an exemplary embodiment of the invention. Before the method shown in FIG. 4, a user may initiate a transaction by presenting a portable communication device 110 to an access device 150. As described above in reference to FIGS. 2-3, the portable communication device 110 may comprise multiple mobile payment applications 140 associated with multiple application identifiers.

The portable communication device 110 may comprise an application linker module 130 that manages, configures, and communicates the application identifiers to the access device 150. When the portable communication device 110 is within communication range with the access device 150, the access device 150 may sense the presence of the portable communication device 110. The access device 150 may identify the presence of the portable communication device 110 through any suitable method associated with wireless communication standards.

At step 401, the access device 150 may communicate with the application linker module 130 of the portable communication device 110 to obtain a list of available payment applications on the portable communication device 110. For example, the access device 150 may send a request for available payment applications stored on the portable communication device 110 to the portable communication device 110. The request may include any relevant information to allow the portable communication device 110 determine that the access device 150 is requesting available payment applications and that an application linker module 130 is configured to respond to the request. Further details regarding exemplary communication protocols between access devices 150 and applications on the secure element 120 of the mobile communication device 110 may be found in U.S. patent application Ser. No. 13/947,984, filed Jul. 22, 2013, by Rigby, et al., which is hereby incorporated by reference in its entirety for all purposes. Additionally, functionality described in the method below may rely on the description provided above in reference to FIGS. 2 and 3 and may reference both figures.

At step 402, the application linker module 130 may receive the request and may determine available payment applications on a secure element 120 using one or more application identifiers stored and associated with the payment applications. As explained above and shown in FIG. 3, at least one of the application identifiers 132-135 may be associated with more than one payment applications 141-144 and one or more payment applications 141-144 may be associated with multiple application identifiers 132-135.

Accordingly, the application linker module 130 may search a payment application routing table 131 for application identifiers associated with payment applications on the portable communication device 110. For example, as shown in FIG. 3, the application linker module 130 may determine that there are 4 different application identifiers (e.g., application identifier #1-#4 132-135) associated with 4 different payment applications (e.g., payment applications #1-#4 141-144).

Additionally, the application linker module 130 may determine status information, priority information, and/or any other configuration details associated with each relationship between an application identifier and a payment application stored in the payment application routing table 131 and may use the information when determining a preferred payment application and/or include the information in the response to the access device 150. For example, the application linker module 130 may determine that payment application #4 144 is inactive and thus, the application linker module 130 may not include the application identifier #4 144 in a list of available application identifiers sent to the access device 150 because the payment application is not available.

At step 403, the application linker 130 generates and sends a list of available payment applications to the access device 150. The list of available payment applications may include application identifiers associated with the available payment applications as well as any other relevant information to an access device 150 for determining supported payment applications and selecting a supported payment application. Accordingly, the list of available payment applications may include a variety of information depending on the configuration details of the access device 150. For example, the list of available payment applications may include application identifiers, mobile payment application indicators (e.g., issuer information, merchant identifier, etc.) associated with the application identifiers, priority information associated with the application identifiers, and any other relevant information to an access device 150 for selecting a payment application.

At step 404, the access device 150 receives the list of available application identifiers and determines whether any application identifiers provided in the list of application identifiers are supported by the access device 150. For example, an application selection module 153 of the access device 150 may compare application identifiers from the received list of available payment applications to supported application information 153A associated with the access device 150. For instance, if the received application identifiers match any of the application identifiers in the supported application information 153A, the application selection module 153 may consider the application identifier and corresponding payment application as supported.

For example, the access device may be configured to process transaction over payment processing network “A” but not over payment processing network “B”. Accordingly, if a portable communication device including only payment applications (and corresponding application identifiers) associated with payment processing network B, the access device may receive the application identifier associated with payment processing network B, compare the application identifier to supported application identifiers in the supported application information 153, and may determine that there is no match (since the application identifiers in the supported application information identify only those application identifiers associated with payment processing network A. However, if the list of available payment applications included application identifiers associated with payment applications including payment information that is configured to be processed on either (or both) payment processing network A and B, then the access device 150 may determine that the application identifiers associated with the payment application of payment processing network A, do match the supported application information 153, and thus, the selection process may continue.

Additionally, if priority information is included in the list of available payment applications, the application selection module 153 of the access device 150 may use priority information associated with the payment application identifiers from the application linker module 130 to determine a preferred supported payment application. Accordingly, the application selection module 153 may determine whether the access device 150 is configured to support or process transactions from any of the received payment application identifiers and where multiple payment applications are included along with priority information for each application identifier, the application selection module 153 of the access device 150 may determine a preferred payment application and/or application identifier based on preferences, priorities, and/or configuration details associated with the access device 150. As described above in relation to FIGS. 2 and 3, the preferences may include authentication and configuration options of the payment applications, transaction limitations, and/or geographical restrictions associated with the access device 150.

Accordingly, the application selection module 153 of the access device 150 may determine the highest priority supported application identifier provided by the application linker 130. For example, if at least one of the available payment application identifiers is associated with more than one payment application, the access device 150 may determine whether the highest priority application identifier is supported before the other lower priority application identifiers. Therefore, in some embodiments, the application selection module 153 of the access device 150 determines supported application identifiers from the list of the available payment application identifiers and selects the highest priority application identifier on the list of received payment application identifiers before moving to payment application configuration preferences of the access device 150 and/or portable consumer device.

Additionally, in some embodiments, the application selection module 153 of the access device 150 may select an application identifier associated with the payment applications based on the preferences associated with the payment application as well as the application identifier. For example, the application selection module 153 of the access device 150 may use authentication processes, configuration details of the payment applications, and any other relevant information to identify a preferred payment application from the list of available payment applications associated with the application identifiers. In those embodiments where a payment application indicator is included in the available payment application, the selection message may also include the payment application indicator to inform the application linker module 130 as to which payment application is the preferred payment application.

At step 405, the access device 150 selects an application identifier and generates a selection message including the selected application identifier in order to communicate to the portable communication device 110 the selected application. The selection message is used to obtain payment information from the selected and supported payment application associated with the application identifier in the provided list of available applications. Thus, the selection message may include any relevant information to the application linker module 130 to allow for identification and selection of an application identifier and/or mobile payment application 140 associated with the selection message. Accordingly, the access device 150 may send the selection message to the portable device in order to obtain payment information associated with the selected application identifier.

At step 406, the application linker module 130 receives the selection message identifying a selected application identifier from the access device 150. Accordingly, an application identifier has now been selected by the access device 150 and the application linker module 130 may determine the payment applications associated with the selected application identifier. For example, the selected application identifier may be associated with at least two of the payment applications installed on the portable communication device 110.

Accordingly, the application linker module 130 may select a payment application from the at least two of the payment applications associated with the selected application identifier received in the selection message. The application linker module 130 may select the payment application associated with the payment identifier through any suitable manner. For example, the priorities of each payment application associated with the application identifier identified in the payment application routing table 131 may be used to determine the most appropriate payment application associated with the selected application identifier.

At step 407, the application linker module 130 may obtain the address information associated with the selected payment application from the payment application routing table and may route the selection message to the selected payment application associated with the selected application identifier. Accordingly, the application linker module 130 may function as a proxy router identifying the software application (e.g., mobile payment application) and the identified data that is being requested from the identified payment application (e.g., payment information). As described above in reference to FIGS. 2-3, the application linker module 130 may route the selection message directly to the payment application (as shown in FIG. 4) or may provide an address (not shown) to the access device 150 (or other application) for contacting the payment application to obtain the stored payment credentials.

At step 408, the payment application obtains payment information associated with the received application identifier in the selection message. In some embodiments, the payment application may store or be associated with multiple application identifiers. Accordingly, in some embodiments, the payment application may determine the payment information associated with the received application identifier from the selection message and use the received application identifier (and any other relevant information contained in the selection message) to determine the appropriate payment information associated with the selection message.

At step 409, the payment application sends the payment information associated with the selected application identifier to the application linker module for communication to the access device 150. In some embodiments, the payment application may directly communicate the payment information to a communication module of the portable communication device 110 for delivery to the access device 150.

At step 410, the application linker module 130 receives the payment information from the selected payment application associated with the selected application identifier and forwards the payment information to the access device 150.

At step 411, the communication module of the access device 150 receives the payment information associated with the selected payment application and the payment authorization module of the access device 150 initiates a transaction using the received payment information. In some embodiments, the payment information may be directly passed as part of an authorization request message and in other embodiments, account information may be obtained from the received payment information and the account information may be used to initiate the transaction.

The initiation may include any number of functions including completing a cardholder verification using methods associated with the particular application identifier, communicating multiple messages back and forth with the portable communication device 110 to obtain the correct information, cardholder approval, etc., or sending messages back and forth between the other entities within the transaction processing eco-system and the portable communication device 110 as necessary or desired for transaction processing.

At step 412, the merchant computer 160 generates an authorization request message using the received payment information from the access device 150 and other transaction information. Accordingly, the authorization request message may include some or all of the received payment information (e.g., payment credentials, application identifier, card verification values, etc.) depending on the configuration of the system and the requirements of the payment processing network. For instance, the authorization request message may include a transaction amount, date, time, product identifiers, merchant identifier, and any other relevant information for determining an account associated with an account, transaction details, and/or processing of a transaction.

At step 413, the merchant computer 160 may then send the authorization request message to an acquirer computer 170 and/or payment processing network for transaction processing.

At step 414, the acquirer computer 170 receives the authorization request message and forwards the authorization request message to a payment processing network computer 180 associated with the account and/or payment credentials included in the authorization request message.

At step 415, the payment processing network computer 180 may receive the authorization request message and determine an account issuer associated with the authorization request message. The payment processing network may then forward the authorization request message to the issuer for authorization of the transaction. Any number of additional fraud analysis, authentication, risk analysis, and/or other actions may be performed by the payment processing network computer 180 (or any of the other computers associated with the authorization request message).

At step 416, the issuer computer 190 receives the authorization request message and determines whether the transaction should be authorized. The issuer may determine the account associated with the authorization request message, compare a value or credit available in the account to the transaction amount, perform any number of fraud checks or risk analysis processes, and/or perform any other relevant actions to determine an appropriate authorization decision.

At step 417, the issuer computer 190 may determine an authorization decision and may generate an authorization response message including the authorization decision. The issuer computer 190 may send the authorization response message to the payment processing network computer 180 for completion and processing of the transaction.

At step 418, the payment processing network computer 180 may receive the authorization response message, log the authorization decision for settlement and clearance purposes, and send the authorization response message to the acquirer computer 170 for reporting to the merchant computer 160 and/or access device 150. In some embodiments, the payment processing network computer 180 may also send a notification to the portable communication device 110 including the authorization decision.

At step 419, the merchant computer 160 receives the authorization response message and completes the transaction based on the authorization decision of the authorization response message. For example, the merchant may provide a good or service if the authorization response message includes an indication of an accepted transaction and may decline to provide a good or service when receiving a declined authorization decision. Although not shown, the merchant computer 160 may provide the authorization response message to the access device 150 and subsequently to the portable communication device 110 for reporting to the payment application and the consumer.

### III. System Devices

The various participants and elements described herein with reference to FIGS. 1-3 may operate one or more computer apparatuses to facilitate the functions described herein. Any of the elements in FIGS. 1-3, including any servers or databases, may use any suitable number of subsystems to facilitate the functions described herein.

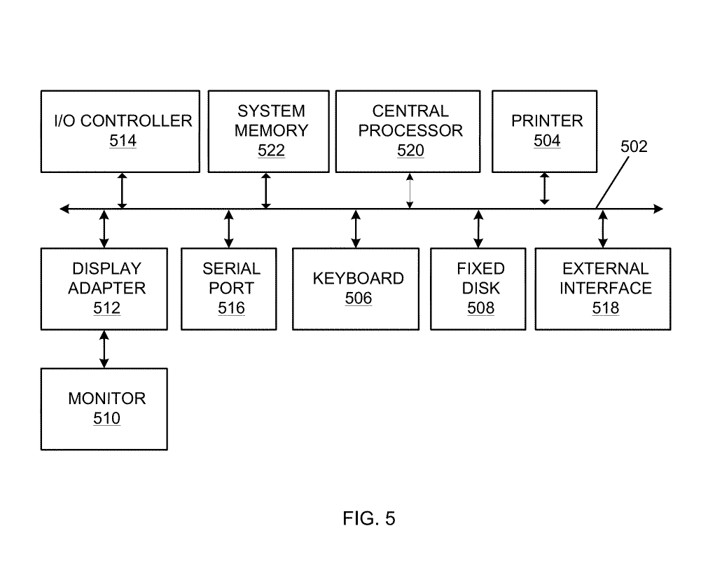

Examples of such subsystems or components are shown in FIG. 5. The subsystems shown in FIG. 5 are interconnected via a system bus 602. Additional subsystems such as a printer 504, keyboard 506, fixed disk 508 (or other memory comprising computer readable media), monitor 510, which is coupled to display adapter 512, and others are shown. Peripherals and input/output (I/O) devices, which couple to I/O controller 514 (which can be a processor or other suitable controller), can be connected to the computer system by any number of means known in the art, such as serial port 516. For example, serial port 516 or external interface 518 can be used to connect the computer apparatus to a wide area network such as the Internet, a mouse input device, or a scanner. The interconnection via system bus allows the central processor 520 to communicate with each subsystem and to control the execution of instructions from system memory 522 or the fixed disk 508, as well as the exchange of information between subsystems. The system memory 522 and/or the fixed disk 508 may embody a computer readable medium.

FIG. 6 is a functional block diagram illustrating a portable communication device that may be used to perform mobile banking operations, such as initiating transactions and receiving and displaying transaction alerts, in accordance with some embodiments of the present invention. Portable communication device 602 may include circuitry that is used to enable certain device functions, such as telephony. The functional elements responsible for enabling those functions may include a processor 604 that is programmed to execute instructions that implement the functions and operations of the device. Processor 604 may access data storage 612 (or another suitable memory region or element) to retrieve instructions or data used in executing the instructions. Data input/output elements 608 may be used to enable a user to input data (via a microphone or keyboard, for example) or receive output data (via a speaker, for example). Display 606 may also be used to output data to a user. Communications element 610 may be used to enable data transfer between device 602 and a wireless network (via antenna 618, for example) to assist in enabling telephony and data transfer functions. Device 602 may also include contactless element interface 614 to enable data transfer between contactless element 616 and other elements of the device, where contactless element 616 may include a secure memory and a near field communications data transfer element (or another form of short range communications technology). As noted, a mobile phone or similar device is an example of a portable communication device that may be used to display alerts as described with reference to embodiments of the present invention. However, other forms or types of devices may be used without departing from the underlying concepts of the invention. Further, devices that are used to display alerts may not require the capability to communicate using a cellular network in order to be suitable for use with embodiments of the present invention.

FIG. 7 is a diagram of a portable consumer device 700 in the form of a card that includes a contactless payment element 702, and that may be used to initiate a transaction, in accordance with some embodiments of the present invention. The payment device depicted in FIG. 7 may be a “smart card” or similar device, such as a credit or debit type card in which a chip is embedded. One form of such a device is known as an EMV (Europay™, MasterCard™ and Visa™) card. In the context of the present invention, EMV refers to a standard for interoperation of integrated circuit (IC) cards (“chip cards”) and IC card capable POS terminals and ATMs, and is used for authenticating credit and debit card payments. The EMV standard defines the interactions at the physical, electrical, data and application levels between IC cards and IC card processing devices for use in financial transactions.

FIG. 7 shows a substrate 704 that provides the form factor for device 700. A contactless element 702 for interfacing with a data access or data transfer device may be present on, or embedded within, substrate 704. Contactless element 702 may include a chip or other form of data storage element. Contactless element 702 may include the capability to communicate and transfer data using a near field communications (NFC) technology or other short range communications technology. Consumer information 706 such as an account number, expiration date, and consumer name may be printed or embossed on the card. Although not necessary for operation as a contactless payment device, device 700 may include a magnetic stripe 708 on substrate 704, where magnetic stripe 708 permits access to contactless element 702. This may be used to provide access to data stored in, or the functions of, the chip that is part of the contactless element by a terminal using a magnetic stripe reader.

Embodiments of the invention are not limited to the above-described embodiments. For example, although separate functional blocks are shown for an issuer, payment processing network, and acquirer, some entities perform all of these functions and may be included in embodiments of invention.

Specific details regarding some of the above-described aspects are provided above. The specific details of the specific aspects may be combined in any suitable manner without departing from the spirit and scope of embodiments of the invention. For example, back end processing, data analysis, data collection, and other transactions may all be combined in some embodiments of the invention. However, other embodiments of the invention may be directed to specific embodiments relating to each individual aspect, or specific combinations of these individual aspects.

It should be understood that the present invention as described above can be implemented in the form of control logic using computer software (stored in a tangible physical medium) in a modular or integrated manner. Based on the disclosure and teachings provided herein, a person of ordinary skill in the art will know and appreciate other ways and/or methods to implement the present invention using hardware and a combination of hardware and software.

Any of the software components or functions described in this application, may be implemented as software code to be executed by a processor using any suitable computer language such as, for example, Java, C++ or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention.

A recitation of “a”, “an” or “the” is intended to mean “one or more” unless specifically indicated to the contrary.

All patents, patent applications, publications, and descriptions mentioned above are herein incorporated by reference in their entirety for all purposes. None is admitted to be prior art.

What is claimed is:

1. A method for initiating a transaction between a portable communication device and an access device, the method comprising:
receiving, by a processor, a request for available applications located on the portable communication device from the access device;
determining, by the processor, application identifiers associated with applications on the portable communication device, wherein at least one of the application identifiers is associated with two or more of the applications; and
sending, by the processor, a list of available applications to the access device, the list of available applications including the determined application identifiers.

2. The method of claim 1, wherein the applications include payment applications and wherein the payment applications store payment information associated with one or more consumer accounts.

3. The method of claim 1, wherein at least one of the applications is associated with two or more of the application identifiers.

4. The method of claim 1, further comprising:
receiving, by the processor, a selection message from the access device, the selection message identifying a selected application identifier;
determining, by the processor, the applications associated with the selected application identifier, wherein the selected application identifier is associated with at least two of the applications;
selecting, by the processor, an application from the at least two of the applications associated with the selected application identifier;
routing, by the processor, the selection message to the selected application associated with the selected application identifier;
receiving, by the processor, information from the selected application associated with the selected application identifier; and
sending, by the processor, the received information to the access device.

5. The method of claim 4, wherein selecting the application associated with the selected application identifier includes determining priorities for the at least two of the applications associated with the selected application identifier and selecting the application with a highest priority.

6. The method of claim 4, wherein before sending the list of available applications to the access device, the method further comprises determining, by the processor, the applications associated with the determined application identifiers, wherein the list of available applications includes application indicators associated with the determined application identifiers; and
wherein selecting the application from the at least two of the applications associated with the selected application identifier comprises determining the selected application from the selection message, wherein the access device selects the selected application by determining supported application identifiers from the list of the available applications and the access device selects the application from the supported application identifiers according to preferences stored by the access device.

7. The method of claim 6, wherein the preferences include authentication and configuration options of the applications or geographical restrictions associated with the access device.

8. The method of claim 1, further comprising:
receiving, by the processor, a request to update a relationship between an application identifier and an application; and
updating, by the processor, an application routing table to include the updated relationship between the application and the application identifier.

9. The method of claim 8, wherein the updated relationship includes removing an association between the application identifier and the application or adding an association between the application identifier and the application.

10. The method of claim 8, wherein the request to update the relationship is received during application provisioning or application personalization.

11. The method of claim 8, wherein the request to update the relationship is received after application provisioning and application personalization.

12. The method of claim 2, wherein the list of available payment applications includes a network-generic application identifier and a network-specific application identifier associated with a payment application.

13. The method of claim 2, wherein the list of available payment applications includes a network-generic application identifier that is associated with two or more payment applications.

14. The method of claim 1, wherein determining the application identifiers associated with the applications stored on the portable communication device includes determining the application identifiers associated with an active application on the portable communication device.

15. A portable communication device comprising:
a processor; and
a computer-readable medium coupled to the processor, the computer-readable medium comprising code, executable by the processor, to perform a method, the method comprising:
receiving a request for available applications located on the portable communication device from the access device;
determining application identifiers associated with applications on the portable communication device, wherein at least one of the application identifiers is associated with two or more of the applications; and
sending a list of available applications to the access device, the list of available applications including the determined application identifiers.

16. A method for initiating a transaction using an application on a portable communication device, the method comprising:
identifying, by an access device, the presence of a portable communication device;
sending, by the access device, a request for available applications to the portable communication device;
receiving, by the access device, a list of the available applications from the portable communication device, the list including application identifiers, wherein at least one of the application identifiers is associated with two or more applications on the portable communication device;
determining, by the access device, supported application identifiers from the list of the available applications;
selecting, by the access device, an application identifier from the supported applications; and
sending, by the access device, a selection message including the selected application identifier to the portable communication device in order to obtain information associated with the selected application identifier.

17. The method of claim 16, wherein the applications include payment applications and wherein the payment applications store payment information associated with one or more consumer accounts.

18. The method of claim 16, wherein the list of available applications includes application indicators associated with the application identifiers and wherein selecting the application identifier from the supported applications further comprises:
determining, by the access device, applications associated with the selected application identifier, wherein the selected application identifier is associated with at least two applications;
determining, by the access device, a preferred application from the at least two applications according to preferences stored by the access device; and
sending, by the access device, the application indicator associated with the preferred application to the portable communication device in the selection message.

19. The method of claim 18, wherein the preferences include authentication and configuration options of the applications.

20. The method of claim 16 further comprising:
receiving, by the access device, the information from the portable communication device; and
initiating the transaction using the received information associated with the selected application identifier.

21. An access device comprising:
a processor; and
a computer-readable medium coupled to the processor, the computer-readable medium comprising code, executable by the processor, to perform a method, the method comprising:
identifying the presence of a portable communication device;
sending a request for available applications to the portable communication device;
receiving a list of the available applications from the portable communication device, the list including application identifiers, wherein at least one of the application identifiers is associated with two or more applications on the portable communication device;
determining supported application identifiers from the list of the available applications;
selecting an application identifier from the supported application identifiers; and
sending a selection message including the selected application identifier to the portable communication device in order to obtain information associated with the selected application identifier.
